(19) United States
(12) Patent Application Publication
(10) Pub. No.: US 2002/0131803 A1
(43) Pub. Date: Sep. 19, 2002

(54) System and method for reducing fatigu of a user of a computer keyboard

(76) Inventors: Ofra Savir, Ramat Gan (IL); Eliezer Traub, Ramat Gan (IL)

Correspondence Address: DR MARK FRIEDMAN LTD., c/o Bill Polkinghorn, Discovery Dispatch, 9003 Florin Way, Upper Marlboro, MD, 20772, US

(21) Appl. No.: 09/809,054

(22) Filed: Mar. 16, 2001

(51) Int. Cl. B41J 5/08; B41J 5/14

(52) U.S. Cl. 400/491.3

(57) ABSTRACT

A system and method for reducing fatigue of a user of a computer. The system includes a keyboard, a display device accessible to a user while the user is looking at the keyboard, a computer capable of receiving data input from the keyboard and displaying the data on a computer monitor; and the computer monitor. Data entered from the keyboard is displayed upon the display device, reducing a need for gaze shifting and reducing fatigue. The method includes the steps of providing a keyboard, placing a display device in a location which makes it accessible to a user of the keyboard while the user is looking at the keyboard and allowing the display device to receive data input from the keyboard and display the data in parallel to display of the data on the computer monitor. The step of allowing the display device to receive data input from the keyboard and display the data encourages a practitioner of the method to keep their gaze on the keyboard, thereby reducing fatigue.

### FIELD AND BACKGROUND OF THE INVENTION

The present invention relates to a system and method for reducing fatigue of a user of a computer and, more particularly, to a small display which is accessible to the user without looking away from the keyboard.

Typing is generally accomplished by the blind method (i.e. touch typing) or by looking at the keyboard while typing (i.e. hunt and peck typing). Historically, most typing was done by professional typists that were well versed in the blind method. However, the advent of personal computers has created a situation in which many unskilled typists spend considerable amounts of time entering data by means of a computer keyboard. Much of this data entry is text entry, i.e. alphanumeric characters. As a result, neck and back pain have become commonplace among these workers. These pains are caused by frequently looking from the keyboard to the computer screen and back to the keyboard. It is estimate that a person entering data into a computer using the hunt and peck method may shift their gaze from the keyboard to a computer monitor as often as 3000 times per hour on average.

The prior art teaches a number of auxiliary display devices which are designed to increase typing efficiency.

U.S. Pat. No. 4,323,315 teaches a display device attached to the keyboard of an electronic typewriter. The purpose of the teachings of this patent is to provide a typist the opportunity to see text before it is printed on paper, thereby offering an opportunity to make a correction prior to printing. The advent of computer screens would seem to obviate the need for the devices taught by this patent.

U.S. Pat. No. 4,934,852 teaches a typewriter with a variable color display. According to teachings of this patent, color changes as typing speed and/or accuracy changes. The teachings indicate that the invention is “ . . . ideally suited for the professional typist and for those who strive to improve and polish their typing skills”. As above, the advent of computer screens would seem to obviate the need for the devices taught by this patent.

U.S. Pat. No. 5,275,494 sought to provide an electronic typewriter with greatly enhanced levels of performance in comparison with a basic model by providing a display. Reduction of errors and increased speed were cited as benefits derived from this typewriter. Also here, the advent of computer screens would seem to obviate the need for the devices taught by this patent.

However, as stated hereinabove, neck and back pain caused by frequently looking from the keyboard to the computer screen and back to the keyboard have become common. Paradoxically, the problem may actually be worsened by larger display monitors which require looking further away from the keyboard. Certainly, the problem is most acute among those typists that employ the hunt and peck method. These typists were not the object of the three U.S. patents cited above.

There is thus a widely recognized need for, and it would be highly advantageous to have, a system and method for reducing fatigue of a user of a computer devoid of the above limitations.

### SUMMARY OF THE INVENTION

According to one aspect of the present invention there is provided a system for reducing fatigue of a user of a computer. The system includes: (a) a keyboard, the keyboard including keys which correspond to letters of an alphabet and at least one item selected from the group consisting of a space key, a shift key, a tab key, keys for numeric digits, at least one symbol key, a carriage return key, keys for punctuation marks and function keys, (b) a display device, the display device accessible to a user of the keyboard while the user is looking at a key of the keyboard, (c) the computer which is capable of receiving data input from the keyboard and displaying the data on a computer monitor; and (d) the computer monitor. Data entered from the keyboard is displayed upon the display device, reducing a need for gaze shifting and reducing fatigue.

According to another aspect of the present invention there is provided a method for reducing fatigue of a user of a computer. The method includes the steps of: (a) providing a keyboard, the keyboard including keys which correspond to letters of an alphabet and at least one item selected from the group consisting of a space key, a shift key, a tab key, keys for numeric digits, at least one symbol key, a carriage return key, keys for punctuation marks and function keys, (b) placing a display device in a location which makes the display device accessible to a user of the keyboard while the user is looking at a key of the keyboard, (c) allowing the display device to receive data input from the keyboard and display the data in parallel to display of the data on a computer monitor. The step of allowing the display device to receive data input from the keyboard and display the data encourages a practitioner of the method to keep their gaze on the keyboard, thereby reducing fatigue.

According to further features in preferred embodiments of the invention described below, the display device and the keyboard have a relationship selected from the group consisting of: (i) the display device is integrally formed with the keyboard, (ii) the display device is connected to the keyboard, (iii) the display device is connectable to the keyboard and (iv) the display device is located in proximity to the keyboard but is not connected thereto.

According to still further features in the described preferred embodiments the display device includes a designated area of a screen of the computer monitor.

According to still further features in the described preferred embodiments the display device is periodically cleared by a specific keystroke.

According to still further features in the described preferred embodiments the specific keystroke is selected from the group consisting of space and carriage return.

According to still further features in the described preferred embodiments the display device is selected from the group consisting of a CRT tube, an LED display, an LCD display, a plasma screen and an audio display.

According to still further features in the described preferred embodiments the computer monitor is selected from the group consisting of a CRT tube, an LED display, an LCD display and a plasma screen.

According to still further features in the described preferred embodiments the display device is capable of displaying at least one of the letters of the alphabet.

According to still further features in the described preferred embodiments the display device is capable of displaying between 8 and 16 of the letters of the alphabet.

According to still further features in the described preferred embodiments the alphabet is at least two alphabets, a switch between the at least two alphabets being accomplished by a predetermined series of keystrokes.

According to still further features in the described preferred embodiments display device is designed and configured for displaying letters of each of the at least two alphabets.

According to still further features in the described preferred embodiments the step of placing includes an action selected from the group consisting of: (i) integrally forming the display device with the keyboard; (ii) connecting the display device to the keyboard; (iii) rendering the display device connectable to the keyboard; and (iv) placing the display device in proximity to the keyboard.

According to still further features in the described preferred embodiments the step of placing includes dedicating a designated area of a screen of the computer monitor to function as the display device.

According to still further features in the described preferred embodiments the method includes the additional step of periodically clearing the display device by means of a specific keystroke.

The present invention successfully addresses the shortcomings of the presently known configurations by providing a system and method for reducing user fatigue associated with data entry from a computer keyboard.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a drawing of one embodiment of a system according to the present invention;

FIG. 2 is a drawing of an additional embodiment according to the present invention;

FIG. 3 is a diagram of one embodiment of a display device suited for use as part of a system according to the present invention;

FIG. 4 is a diagram of one embodiment of a keyboard suited for use as part of a system according to the present invention showing possible placements of the display device of FIG. 3;

FIG. 5 is a flow diagram showing steps in a method according to the present invention.

### DESCRIPTION OF THE PREFERRED EMBODIMENTS

The present invention is of a system and method for reducing fatigue of a user of a computer which rely upon a small display which is accessible to the user without looking away from the keyboard. Specifically, the present invention can be used to greatly reduce the frequency with which a person performing data entry must shift their gaze from a computer keyboard to a computer monitor.

For purposes of this specification and the accompanying claims, the term “fatigue” is to be construed in its broadest possible sense. As such, the term specifically includes, but is not limited to, muscle fatigue, eye-strain, headaches, inflammation of joints, inflammation of nerves, tendonitis, progressive malformation of bones as a result of ergonomic stress, damage to cartilage (e.g. inter vertebral discs) and other forms of discomfort or damage.

The principles and operation of a system and method for reducing fatigue of a user of a computer according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

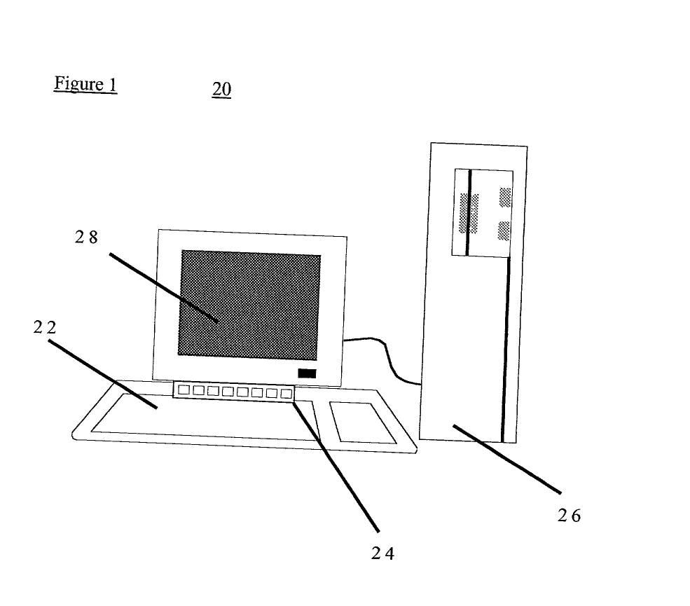

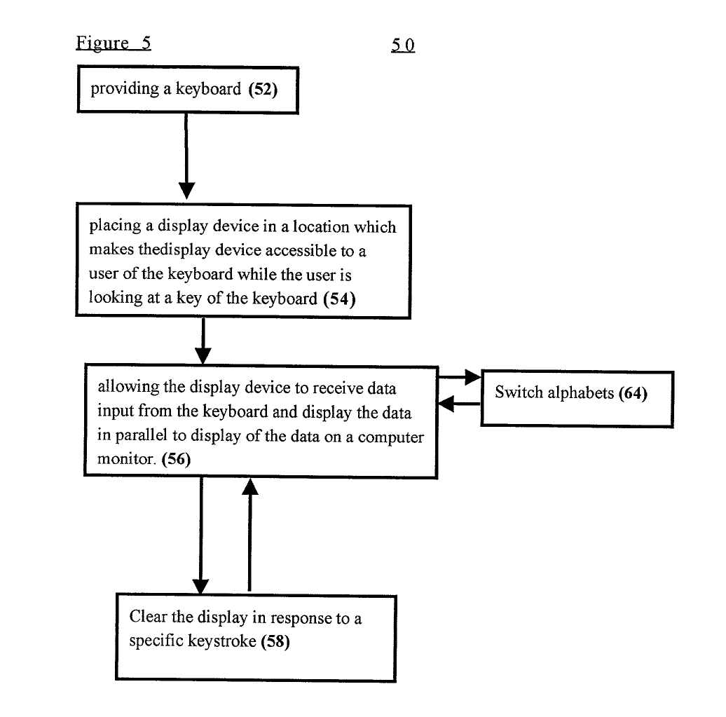

Referring now to the drawings, FIG. 1 illustrates a system 20 for reducing fatigue of a user of a computer 26. System 20 includes a keyboard 22. Keyboard 22 (FIG. 4) includes keys 46 which correspond to letters of an alphabet. Typically keyboard 22 further includes additional keys, including but not limited to, a space key 32, a shift key 34, a tab key 36, keys for numeric digits 38, at least one symbol key 40, a carriage return key 48, keys for punctuation marks 42 and function keys 44. Data entered from the keyboard is displayed upon a display device 24, reducing a need for gaze shifting and reducing fatigue.

System 20 further includes the display device 24 which is visually accessible to a user of keyboard 22 while the user is using keyboard 22. Display device 24 and keyboard 22 may be arranged in a variety of configurations including, but not limited to, display device 24 is integrally formed with keyboard 22, display device 24 is connected to keyboard 22, display device 24 is connectable to keyboard 22 and display device 24 is located in proximity to keyboard 22 but is not connected thereto.

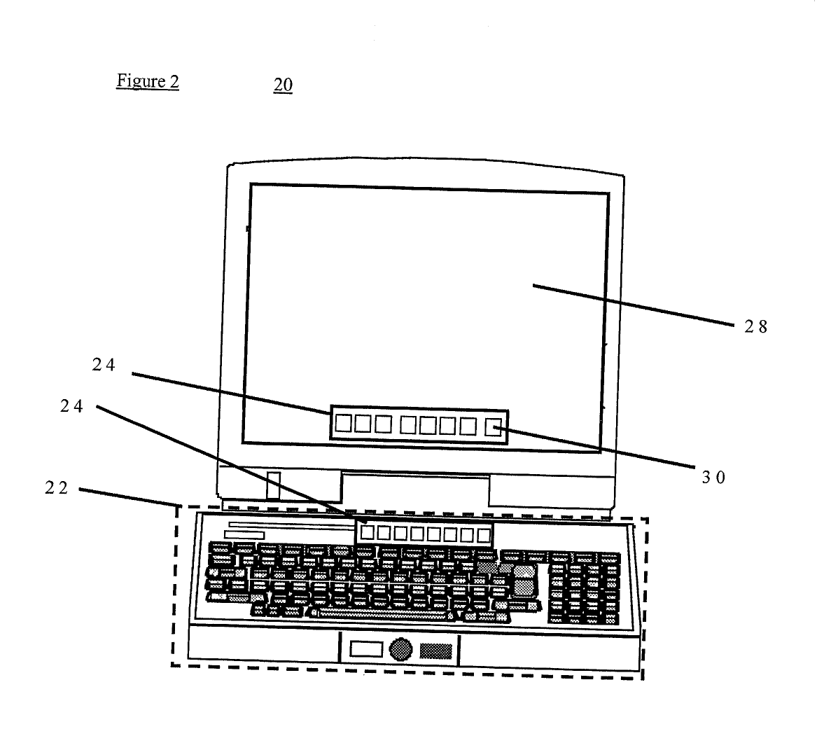

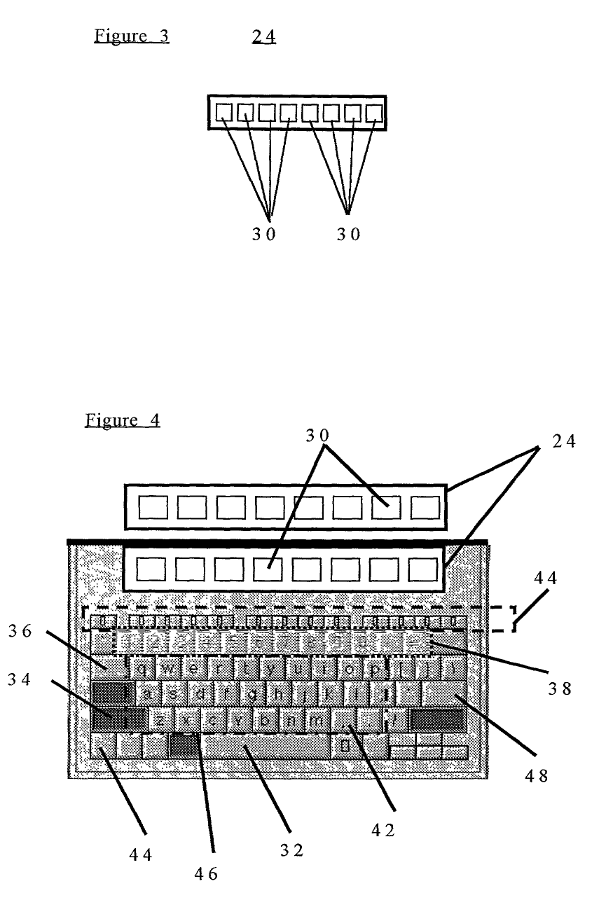

In some cases, display device 24 may be, for example, a designated area of a screen of computer monitor 28 (FIG. 2). Such a configuration is especially usefully if system 20 is applied to a lap-top or notebook computer. In these types of computers, monitor 28 is typically in close proximity to keyboard 22. Display device 24, may be, for example, a CRT tube, an LED display, an LCD display, a plasma screen or an audio display.

Display device 24 is capable of displaying at least one of the letters of the alphabet in response to data entry by an operator of keyboard 22. Display 24 may be further capable of displaying other symbols, numbers or functions in some cases. Preferably, display device 24 is capable of displaying a full word. Therefore, display device 24 is preferably constructed to display between 1 and 20, more preferably between 5 and 18, and most preferably between 8 and 16 of the letters of the alphabet at one time.

In some cases the alphabet may be at least two alphabets. In such cases a switch between the at least two alphabets may be accomplished by a predetermined series of keystrokes, such that display device 24 is designed and configured for displaying letters of each of the at least two alphabets in accord with user preferences designated from keyboard 22.

Regardless of the exact configuration or position of display device 2 24, it is often advantageous if display device 24 is periodically cleared by a specific keystroke such as space 32 and carriage return 48. In this way, a user is always able to observe, for example, the word they are currently typing.

System 20 further includes a computer 26 capable of receiving data input from keyboard 22 and displaying the data on computer monitor28. In most cases, monitor 28 is a dedicated computer monitor. However, monitor 28 may also be a device with additional uses, for example a television set. System 20 further includes the computer monitor 28 which may be, for example, a CRT tube, an LED display, an LCD display or a plasma screen.

The present invention is further embodied by a method 50 (FIG. 5) for reducing fatigue of a user of a computer. The method includes the step of: providing 52 a keyboard 22. The keyboard includes keys which correspond to letters 46 of an alphabet and at least one item selected from the group consisting of a space key 32, a shift key 34, a tab key 36, keys for numeric digits 38, at least one symbol key, a carriage return key 48, keys for punctuation marks 42 and function keys 44.

Method 50 further includes the step of placing 54 display device 24 in a location which makes display device 24 accessible to a user of keyboard 22 while the user is looking at a key of keyboard 22.

Method 50 further includes the step of allowing 56 display device 24 to receive data input from keyboard 22 and display the data in parallel to display of the data on computer monitor28. The step of allowing 56 display device 24 to receive data input from keyboard 22 and display the data encourages a practitioner of the method to keep their gaze on the keyboard, thereby reducing fatigue.

The step of placing 54 may be accomplished, for example, by integrally forming display device 24 with keyboard 22, by connecting display device 24 to keyboard 22, by rendering display device 24 connectable to keyboard 22 or by placing display device 24 in proximity to keyboard 22. Alternately or additionally, the step of placing 54 may involve dedicating a designated area of a screen of the computer monitor to function as the display device (FIG. 2).

Method 50 may further include the additional step of periodically clearing the display device by means of a specific keystroke. The keystroke may be, for example, space or carriage return.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for reducing fatigue of a user of a computer, the system comprising:
(a) a keyboard, said keyboard comprising keys which correspond to letters of an alphabet and at least one item selected from the group consisting of a space key, a shift key, a tab key, keys for numeric digits, at least one symbol key, a carriage return key, keys for punctuation marks and function keys;
(b) a display device, said display device accessible to a user of said keyboard while said user is looking at a key of said keyboard;
(c) the computer, the computer being capable of receiving data input from said keyboard and displaying said data on a computer monitor; and
(d) said computer monitor;
wherein data entered from said keyboard is displayed upon said display device, reducing a need for gaze shifting and reducing fatigue.

2. The system of claim 1, wherein said display device and said keyboard have a relationship selected from the group consisting of:
(i) said display device is integrally formed with said keyboard;
(ii) said display device is connected to said keyboard;
(iii) said display device is connectable to said keyboard; and
(iv) said display device is located in proximity to said keyboard but is not connected thereto.

3. The system of claim 1, wherein said display device comprises a designated area of a screen of said computer monitor.

4. The system of claim 1, wherein said display device is periodically cleared by a specific keystroke.

5. The system of claim 4, wherein said specific keystroke is selected from the group consisting of space and carriage return.

6. The system of claim 1, wherein said display device is selected from the group consisting of a CRT tube, an LED display, an LCD display, a plasma screen and an audio display.

7. The system of claim 1, wherein said computer monitor is selected from the group consisting of a CRT tube, an LED display, an LCD display and a plasma screen.

8. The system of claim 1, wherein said display device is capable of displaying at least one of said letters of said alphabet.

9. The system of claim 8, wherein said display device is capable of displaying between 8 and 16 of said letters of said alphabet.

10. The system of claim 1, wherein said alphabet is at least two alphabets, a switch between said at least two alphabets being accomplished by a predetermined series of keystrokes.

11. The system of claim 10, wherein said display device is designed and configured for displaying letters of each of said at least two alphabets.

12. A method for reducing fatigue of a user of a computer, the method comprising the steps of:
(a) providing a keyboard, said keyboard comprising keys which correspond to letters of an alphabet and at least one item selected from the group consisting of a space key, a shift key, a tab key, keys for numeric digits, at least one symbol key, a carriage return key, keys for punctuation marks and function keys;
(b) placing a display device in a location which makes said display device accessible to a user of said keyboard while said user is looking at a key of said keyboard;
(c) allowing said display device to receive data input from said keyboard and display said data in parallel to display of said data on a computer monitor;
wherein said step of allowing said display device to receive data input from said keyboard and display said data encourages a practitioner of the method to keep their gaze on said keyboard, thereby reducing fatigue.

13. The method of claim 12, wherein said step of placing includes an action selected from the group consisting of:
(i) integrally forming said display device with said keyboard;
(ii) connecting said display device to said keyboard;
(iii) rendering said display device connectable to said keyboard; and
(iv) placing said display device in proximity to said keyboard.

14. The method of claim 12, wherein said step of placing includes dedicating a designated area of a screen of said computer monitor to function as said display device.

15. The method of claim 12, comprising the additional step of periodically clearing said display device by means of a specific keystroke.

16. The system of claim 15, wherein said specific keystroke is selected from the group consisting of space and carriage return.

17. The method of claim 12, wherein said step of placing said display device includes placing an item selected from the group consisting of a CRT tube, an LED display, an LCD display, a plasma screen and an audio display.

18. The method of claim 12, wherein said computer monitor is selected from the group consisting of a CRT tube, an LED display, an LCD display and a plasma screen.

19. The method of claim 12, wherein said display device is designed and configured for displaying at least one of said letters of said alphabet.

20. The method of claim 19, wherein said display device is designed and configured for displaying between 8 and 16 of said letters of said alphabet.

21. The method of claim 12, wherein said alphabet is at least two alphabets, a switch between said at least two alphabets being accomplished by a predetermined series of keystrokes.

22. The system of claim 21, wherein display device is designed and configured for displaying letters of each of said at least two alphabets.
